(19) United States
(12) Patent Application Publication
(10) Pub. No.: US 2003/0157410 A1
(43) Pub. Date: Aug. 21, 2003

(54) Polymer electrolyte

(76) Inventors: Christine Ruth Jarvis, Oxfordshire (GB); Alison Jane Macklin, Oxfordshire (GB); William James Macklin, Oxfordshire (GB); Fazlil Coowar, Sugarland, TX (US)

Correspondence Address: William H Holt, Law Offices of William H Holt, First Floor Unit 2, 1423 Powhatan Street, Alexandria, VA, 22314, US

(21) Appl. No.: 10/333,604

(22) PCT Filed: Jul. 13, 2001
(86) PCT No.: PCT/GB01/03165

(30) Foreign Application Priority Data
Jul. 31, 2000 (GB) 0018635.3

(51) Int. Cl. H01M 10/40; H01M 6/18

(52) U.S. Cl. 429/316; 429/309; 429/324

(57) ABSTRACT

A polymer electrolyte comprises a polymer combined with a solution of a salt in a plasticising solvent, and the polymer is a terpolymer of vinylidene fluoride (VdF), hexafluoropropylene (HFP), and chlorotrifluoroethylene (CTFE). The proportion by weight of vinylidene fluoride is at least 85%. The polymer has a large enough molecular weight that its melt flow index, at 230 ° C. and 21.6 kg, is less than 5.0 g/10 min. The resulting polymer electrolyte may be referred to as a solid electrolyte or a gelled electrolyte, and is suitable for use as the separator/electrolyte in an electrochemical cell, such as a secondary lithium ion cell.

This invention relates to a polymer electrolyte for use in electrochemical cells, and to an electrochemical cell incorporating this electrolyte.

For many years it has been known to make rechargeable cells with lithium metal anodes, and cathodes of a material into which lithium ions can be intercalated or inserted. Such cells may use a separator such as filter paper or polypropylene saturated with, as electrolyte, a solution of a lithium salt in an organic liquid such as propylene carbonate. Alternatively a polymer-based solid electrolyte may be used. A wide variety of intercalation materials are known as cathode materials, such as lithium cobalt oxide, and such materials may be mixed with solid electrolyte material to form a composite cathode. It is also known to use an intercalation material such as graphite as the anode material in place of metallic lithium, and this also may be mixed with a solid electrolyte material to form a composite anode.

Polymer electrolytes-comprising a polymer matrix plasticised with a solution of a lithium salt in an organic solvent have also been suggested. For example Gozdz et al. (U.S. Pat. No. 5,296,318 and WO 95/15589) described compositions comprising a copolymer of 75 to 92% by weight vinylidene fluoride and 8 to 25% hexafluoropropylene; this copolymer can be combined with a lithium salt and a plasticising solvent such as ethylene carbonate/propylene carbonate to provide a stable film with adequate electrical conductivity; GB 2 309 703 (AEA Technology) described the use, in making an electrolyte, of a homopolymer polyvinylidene fluoride (PVdF); this polymer can be combined with a salt and a plasticising-solvent, and cast from a suitable solvent to produce a good quality electrolyte film. The homopolymer is characterized by having an exceptionally low melt flow index. Melt flow index is a parameter commonly used in specifying plastics materials, and is measured by the method specified in standard ASTM D 1238.

A limitation on the use of the homopolymer PVdF described in the AEA Technology patent mentioned above is that only a limited range of casting solvents are available for the polymer at room temperature: dimethyl acetamide (DMA), dimethyl formamide (DMF), or N-methyl-pyrrolidone (NMP). These solvents have moderately high boiling points (above 150° C.), and therefore require harsh drying conditions to ensure complete removal of the solvent, and such drying conditions tend to remove some of the plasticising solvent. The use of copolymers of vinylidene fluoride and hexafluoropropylene means that a wider range of casting solvents can be used, some of which are more volatile and so of significantly lower boiling point, and easier to remove after casting. However the presence of the hexafluoropropylene in the polymer is somewhat detrimental to the mechanical properties of the resulting electrolyte film at temperatures above ambient.

According to the present invention there is provided a polymer electrolyte comprising a polymer combined with a solution of a salt in a plasticising solvent, wherein the polymer is a terpolymer of vinylidene fluoride (VdF), hexafluoropropylene (HFP), and chlorotrifluoroethylene (CTFE), the proportion by weight of vinylidene fluoride being at-least 85%, and the polymer has a melt flow index, at 230° C. and 21.6 kg, of less than 5.0 g/10 min.

The polymers of the present invention cover a range of compositions, many of which have a higher proportion of vinylidene fluoride than Gozdz et al. teach as being the maximum for formation of a satisfactory film. Nevertheless, as with the PVdF homopolymer discussed above, because of its low melt flow index (and high molecular weight) it has been found that good quality films can be made, mechanically strong, and with high electrical conductivity. The proportion by weight of hexafluoropropylene is preferably between 2 and 8%, while the proportion by weight of chlorotrifluoroethylene is preferably between 1 and 4%. The preferred compositions are 6 to 7.5% HFP and 2 to 3% CTFE. To some extent the CTFE compensates for the disadvantageous effects of the HFP component, for example in enabling the polymer to absorb more plasticising solvent, and in increasing the melting point temperature.

Preferably the molecular weight is sufficiently high that the melt flow index, at 230° C. and 21.6 kg, is less than 3.0 g/10 min; that corresponds to a melt flow index, at 230° C. and 10 kg, of less than about 1.0 g/10 min.

The present invention also provides an electrochemical cell, in particular a secondary lithium cell, incorporating as electrolyte the polymer electrolyte defined above. The said terpolymer may also be used as a binder in making a composite electrode for an electrochemical cell.

The invention will now be further and more particularly described, by way of example only, and with reference to the accompanying drawings in which:

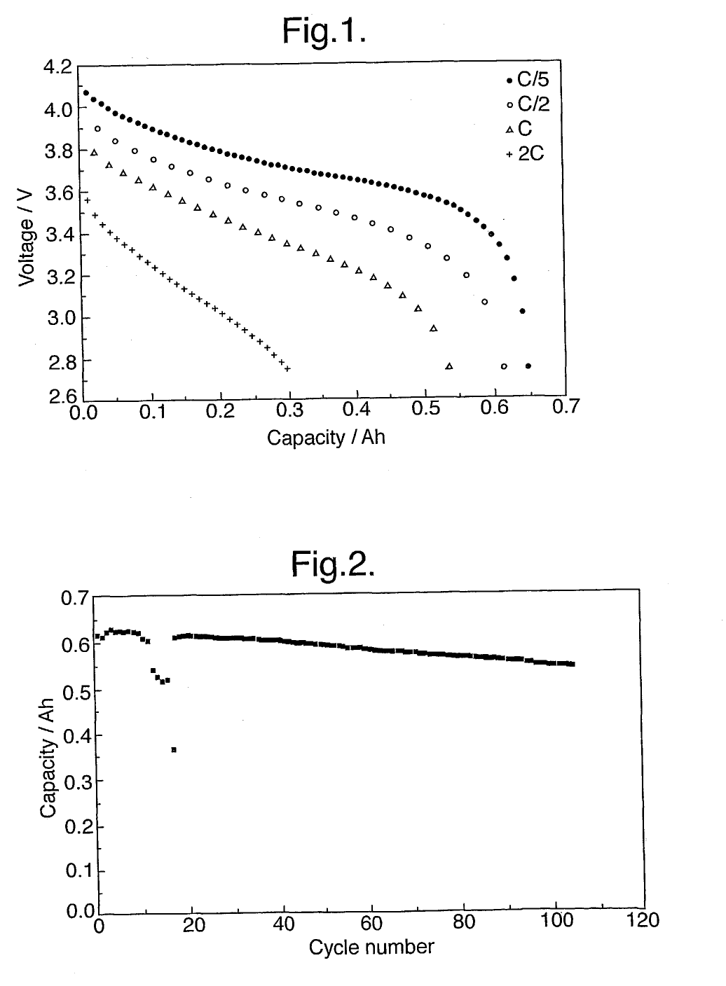

FIG. 1 shows graphically the variation of voltage with cell capacity, during discharge, for a cell incorporating a polymer electrolyte;

FIG. 2 shows graphically the cell capacity of a ell (similar to that of FIG. 1) during the first 100 charge/discharge cycles;

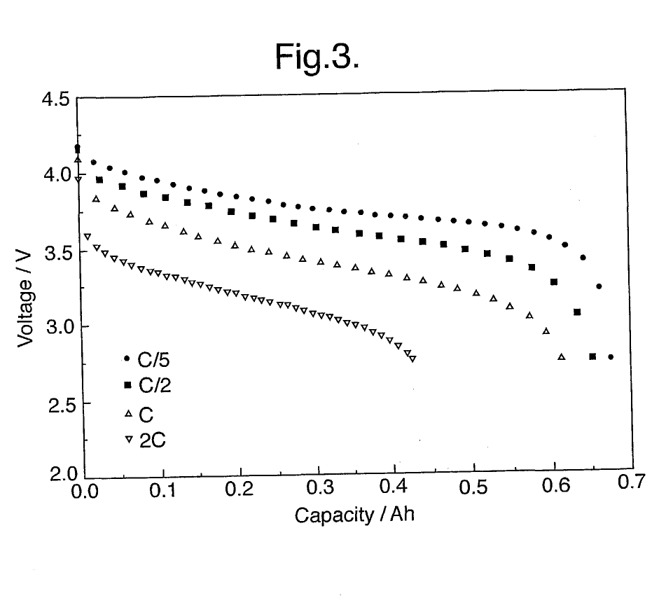

FIG. 3 shows graphically the variation of voltage with-cell capacity, during discharge, for an alternative cell incorporating a polymer electrolyte; and

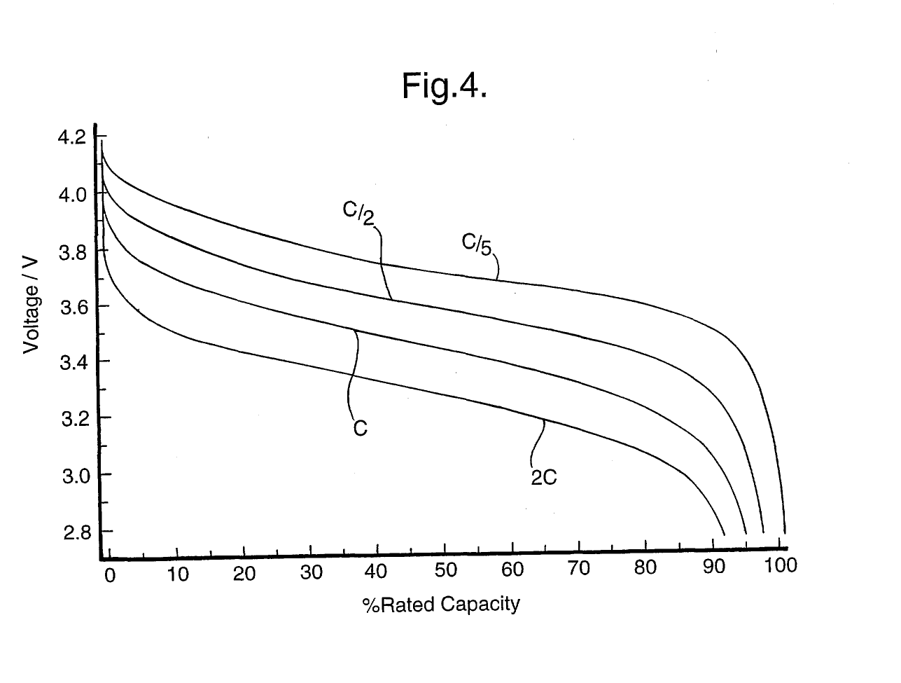

FIG. 4 shows graphically the variation of voltage with cell capacity, during discharge, for another alternative cell incorporating a polymer electrolyte

The polymers used in the electrolytes described below were made by Solvay. The method of manufacture is a suspension polymerization process. In this process the monomers are reacted in an aqueous suspension at-elevated temperature and pressure, in the presence of a non-surfactant suspending agent. An organic initiator and a chain-transfer agent are also used.

For example, 1950 g of demineralised water was introduced into a 4 litre pressure vessel equipped with a double-walled heating jacket, and a stirrer system turning at 880 revolutions per minute. A cellulosic ether suspending agent (such as hydroxypropyl methyl cellulose) was then added as an aqueous solution, to provide 0.1 g suspending agent per 100 g of the monomers to be added. Substantially all the oxygen present in the pressure vessel was removed by evacuating five times down to 40 mbar (4 kPa), at 14° C., and after the first four evacuations returning the pressure vessel to atmospheric pressure with nitrogen.

An initiator, 7.42 g of t-amyl perpivalate (t-pentyl-peroxy-trimethylacetate), and a chain-transfer agent, 6.97 g of diethyl carbonate, were then added at the same time. After 5 minutes the monomers were added: 35 grams of chlorotrifluoroethylene, 174 grams of hexafluoropropylene and 1184 grams of vinylidene fluoride, these being introduced in this order into the pressure vessel. These quantities correspond to 2.5% chlorotrifluoroethylene, 12.5% hexafluoropropylene and 85% vinylidene fluoride. The pressure vessel was then heated progressively up to a maximum temperature of 55° C., and-this maximum temperature was maintained for 5 hours. During this time the pressure in the vessel was held at 120 bar (12 MPa) by injecting additional water.

At the end of this polymerization-stage, the aqueous suspension was degassed by reducing the pressure to atmospheric pressure, and the polymer recovered by filtration. The polymer was then mixed with clean water in a stirred tank, and after washing, was dried to constant weight in a drying cabinet at 60° C. The overall conversion of monomer to polymer was 86%. The resulting vinylidene fluoride-based terpolymer was used in the following examples of electrolytes. It contains 7.4 weight % HFP and 2.8 weight % of CTFE; it has a melt flow index of 2.26 g/10 min at 230° C. and 21.6 kg, and it has a weight average molecular weight of 281,000.

A plasticised polymer film was made by dissolving equal weights of the terpolymer and ethylene carbonate (8 g of each) in dimethyl carbonate as volatile solvent (59 g). This solution was then coated onto an aluminium foil substrate by a doctor blade coating technique at a web speed of 2 m/min, and passed through-a two zone dryer at temperatures of 70 and 100° C. The resulting film was 4-5 μm thick. The polymer film was then peeled off the substrate.

Test cells were then assembled with the polymer film sandwiched between a cathode and an anode. The cathode consisted of LiCoO₂ and carbon, with a binder of PVdF homopolymer, coated onto an aluminium foil current collector. The anode consisted of mesocarbon microbeads (particle size 10 μm, heat treated at 2800° C.) and graphite, with a PVdF homopolymer binder, coated onto a copper foil current collector. These cell components were wound into a spiral, and then vacuum filled with a plasticising liquid electrolyte: 1.2 molar LiPF₆ in ethylene carbonate/ethyl methyl carbonate mixture. Each cell was then stored for 16 hours to ensure the electrolyte had been absorbed by all the cell components, and was then vacuum packed in a flexible packaging material.

Each cell was then subjected to repeated charge and discharge cycles. From the quantity of active material in each cell, the calculated cell capacity was about 0.7 Ah. The rated capacity of each cell was initially measured by charging and then discharging a few times at a current of 120 mA (that is to say at the C/5 rate, assuming the capacity is 0.6 Ah). The discharge behaviour at different discharge currents was then observed.

Referring to FIG. 1, this shows subsequent discharge graphs for one such cell at different discharge currents, each graph showing the variation in cell voltage against the total charge withdrawn from the cell during that discharge. It will be observed that the smaller the discharge current, the more charge can be obtained from the cell. At a discharge current numerically equal to a fifth of the rated cell capacity (i.e. C/5) the capacity available from the cell is 0.65 Ah, whereas at a discharge current numerically equal to the rated cell capacity (i.e. C) the available capacity is only about 0.54 Ah. In addition, the larger the discharge current, the lower is the cell voltage.

Referring now to FIG. 2, this shows the available capacity measured during discharge, for one such cell subjected to over 100 successive charge and discharge cycles. The lower values of capacity obtained on cycles 11-17 were because on those cycles higher rates of discharge were used; all the other discharges were performed at the C/5 rate. It will be observed that over these 100 cycles the capacity decreased by only 14%, from about 0.63 Ah to 0.54 Ah.

An alternative type of polymer film was made by dissolving 1 part by weight of the terpolymer (as described above), in a mixed solvent consisting of 9 parts acetone and 1.25 parts 2-butanol. Acetone is a solvent for the polymer, whereas 2-butanol is not a solvent for the polymer, but it dissolves in the acetone. This solution was then coated onto an aluminium foil substrate by a doctor blade coating technique at a web speed of 0.6 m/min, and passed through a two zone dryer at temperatures of 50 and 70° C. The resulting polymer film was vacuum dried for 16 hours to ensure all the acetone and 2-butanol had evaporated, and was then peeled off the substrate. This process is similar to that described in pending application PCT/GB00/04889, and is expected to form a microporous film as both the acetone and the 2-butanol evaporate.

Test cells were then assembled with the polymer film sandwiched between a cathode and an anode. The anode and the cathode were as described above. These cell components were wound into a spiral, and then vacuum filled with a plasticising liquid electrolyte: 1.2 molar LiPF₆ in ethylene carbonate/ethyl methyl carbonate mixture. Each cell was then stored for 16 hours to ensure the electrolyte had been absorbed by all the cell components, and was then vacuum packed in a flexible packaging material.

Each cell was then subjected to repeated charge and discharge cycles. As described above, the cell was first discharged at an estimate of the C/5 rate, and the observed capacity during that discharge enabled a more accurate measure of cell capacity C to be obtained. The cell was then discharged at different rates. Referring now to FIG. 3, this shows subsequent discharge graphs forgone such cell at different discharge currents, the graph showing the variation in cell voltage against the total charge withdrawn from the cell during that discharge. As with the cell described in relation to FIG. 1, the smaller the discharge current, the more charge can be obtained from the cell. At a discharge current numerically equal to a fifth of the rated cell capacity (i.e. C/5) the capacity available from the cell is about 0.68 Ah, and even at a discharge current equal to the rated cell capacity (i.e. C) the available capacity is still about 0.61 Ah, so this cell clearly has significantly larger-capacity and a better rate performance than the cell described in relation to FIG. 1.

A microporous film giving even better electrical properties has been made by first making a 15 weight % solution of the terpolymer in dimethyl formamide. To 200 g of this solution are added 50 g octanol dropwise with continuous stirring. After thoroughly stirring this mixture it is cast by a doctor blade coating technique onto an aluminium foil substrate, at a web speed of 0.5 m/min with a blade gap of 0.25 mm. This is passed through a two zone dryer at temperatures of 55° C. and 100° C., in which the film is contacted with dehumidified air, so evaporating the dimethyl formamide solvent and the octanol non-solvent, producing a film about 20 μm thick with a porosity about 50%.

This microporous film has been used to make test cells in the way described above, the cells being vacuum filled with the plasticising liquid electrolyte 1.2 M LiPF₆ in ethylene carbonate/ethyl methyl carbonate mixture as before. Each cell was then subjected to charge and discharge cycles in the manner described above. Referring now to FIG. 4, this shows subsequent discharge graphs for one such cell at different discharge currents, the voltage during discharge being plotted against the percentage of the rated capacity. It will be appreciated that the cell capacity at the higher discharge rates is markedly better than in the previously described cell, being above 90% even at a discharge rate of 2C.

1. A polymer electrolyte comprising a polymer combined with a solution of a salt in a plasticising solvent, wherein the polymer is a terpolymer of vinylidene fluoride (VdF), hexafluoropropylene (HFP), and chlorotrifluoroethylene (CTFE), the proportion by weight of vinylidene fluoride being at least 85%, and the polymer has a melt flow index, at 230° C. and 21.6 kg, of less than 5.0 g/10 min.

2. A polymer electrolyte as claimed in claim 1 in which the proportion by weight of hexafluoropropylene is between 2 and 8%.

3. A polymer electrolyte as claimed in claim 2 in which the proportion by weight of hexafluoropropylene is between 6 and 7.5%.

4. A polymer electrolyte as claimed in any one of the preceding claims in which the proportion by weight of chlorotrifluoroethylene is between 1 and 4%.

5. A polymer electrolyte as claimed in claim 4 in which the proportion by weight of chlorotrifluoroethylene is between 2 and 3%.

6. A polymer electrolyte as claimed in any one of the preceding claims wherein the molecular weight is sufficiently high that the melt flow index, at 230° C. and 21.6 kg, is less than 3.0 g/10 min.

7. A polymer electrolyte as claimed in any one of the preceding claims formed by immersing a microporous sheet of polymer in a plasticising electrolyte solution.

8. An electrochemical cell incorporating as electrolyte the polymer electrolyte as claimed in any one of the preceding claims.

9. A polymer electrolyte substantially as hereinbefore described with reference to FIG. 1 and FIG. 2, or FIG. 3, of the accompanying drawings.

10. The use, in the production of an electrochemical cell, of a polymer composition comprising a terpolymer of vinylidene fluoride, hexafluoropropylene, and chlorotrifluoroethylene.
